(19) United States
(12) Patent Application Publication
(10) Pub. No.: US 2014/0193138 A1
(43) Pub. Date: Jul. 10, 2014

(54) SYSTEM AND A METHOD FOR CONSTRUCTING AND FOR EXCHANGING MULTIMEDIA CONTENT

(71) Applicant: Ilan KOREN, Rishon lezion (IL)

(72) Inventor: Ilan KOREN, Rishon lezion (IL)

(21) Appl. No.: 14/150,782

(22) Filed: Jan. 9, 2014

Related U.S. Application Data
(60) Provisional application No. 61/750,849, filed on Jan. 10, 2013.

(51) Int. Cl. G11B 27/031

(52) U.S. Cl. CPC G11B 27/031
USPC 386/281

(57) ABSTRACT

The subject matter discloses a multimedia content editing method; comprising at a computerized device having one or more processors and memory: receiving a command for editing a first multimedia content and encoding the command to metadata; wherein the metadata being used for the editing of the first multimedia content; thereby generating a second multimedia content from the first multimedia content according to the metadata.

### BACKGROUND OF THE INVENTION

The present disclosure relates to video in general, and to video editing, in particular

Video editing is the process of editing segments of motion video production footage, special effects and sound recordings. Typically, the editing includes adding sounds, text and animations, positioning or moving the animation and changing characteristics of the animation.

Existing video editing systems such as Adobe Premiere and Moviemaker provide limited ability to edit video films mainly via a personal computer or via a laptop.

### BRIEF SUMMARY OF THE INVENTION

One exemplary embodiment of the disclosed subject matter is a multimedia content method, comprising at a computerized device having a processor and a memory: receiving a command for editing a first multimedia content; encoding the command; thereby providing an encoded command; and recording the encoded command in a metadata file; wherein the metadata file being used for generating an edited multimedia content from the first multimedia content according to the metadata file. According to some embodiments the method further comprises the step of generating the edited multimedia content from the first multimedia content according to the metadata file.

According to some embodiments the method further comprises the step of previewing effects of the command on the first multimedia content according to the metadata file. According to some embodiments the encoded command comprises one member of a group consisting of: adding a multimedia object, changing a location of a multimedia object, deleting a multimedia object, changing a characteristic of a multimedia object and defining a path for moving a multimedia object. According to some embodiments the encoded command comprises an identification of the multimedia object. According to some embodiments the metadata file comprising one member of a group consisting of an operational code of the command, start time, end time and an identification of a multimedia object. According to some embodiments the operational code of the command further comprises drawing a path for moving a multimedia object on the multimedia content; wherein the recording further comprises recording a position in the path of the multimedia object. According to some embodiments the encoding further comprises translating the position to a relative position on a first screen of the computerized device.

According to some embodiments the method further comprises translating the relative position to an actual position on a second screen. According to some embodiments the encoding further comprises assigning a time stamp relative to a length of the path and to the period in which the path is drawn. According to some embodiments the method further comprises locating the multimedia object in the actual position at the time stamp.

One other exemplary embodiment of the disclosed subject matter is a multimedia content method; comprising at a computerized device having a processor and a memory: receiving a command for editing a first multimedia content; encoding the command; thereby providing an encoded command; recording the encoded command in a metadata file; and generating an edited multimedia content from the first multimedia content according to the metadata file.

One other exemplary embodiment of the disclosed subject matter is a multimedia content generating method; comprising at a computerized device having a processor and a memory: receiving a metadata file; receiving a multimedia content; decoding a command from the metadata file; thereby providing a decoded command; and generating an edited multimedia content from the first multimedia content and from the decoded command; thereby providing an edited multimedia content from the multimedia content according to the metadata file.

One other exemplary embodiment of the disclosed subject matter is an apparatus, the apparatus comprising: a communication unit configured for receiving a command for editing a first multimedia content; a processor configured for encoding the command; thereby providing an encoded command and for recording the encoded command in a metadata file; wherein the metadata file being used for generating an edited multimedia content from the first multimedia content according to the metadata.

One other exemplary embodiment of the disclosed subject matter is an apparatus, the apparatus comprising: a communication unit configured for receiving a metadata file and for receiving a multimedia content; and a processor, configured for decoding a command from the metadata file; thereby providing a decoded command and for generating an edited multimedia content from the first multimedia content and the decoded command.

One other exemplary embodiment of the disclosed subject matter is a method for moving a multimedia object on a multimedia content; the method comprises: receiving a position of a multimedia object along a path drawn by a user; translating the position to a relative position on a first screen; and assigning a time stamp to the position wherein the time stamp being relative to a length of the path and to the period in which the path is drawn; thereby providing a metadata for the moving of the multimedia object.

According to some embodiments the method further comprises the step of translating the relative position to an actual position on a second screen. According to some embodiments the method further comprises the step of locating the multimedia object in the actual position at the time stamp.

One other exemplary embodiment of the disclosed subject matter is a method for moving a multimedia object on a multimedia content; comprising, at a computerized device having a processor and a memory: receiving a metadata file; extracting a relative position from the metadata file; and translating the relative position to an actual position of a screen of the computerized device; extracting a time from the metadata file; extracting a metadata object from the metadata file; and locating the metadata object on the actual position of the screen; wherein the locating being at the time stamp.

One other exemplary embodiment of the disclosed subject matter is an apparatus recording a drawn path for moving a multimedia object on a multimedia content; the apparatus comprising: a processor configured for encoding a position in the path of the multimedia object; wherein the encoding further comprises translating the position to a relative position on a first screen and for assigning a time stamp to the position wherein the time stamp being relative to a length of the path and to the period in which the path is drawn.

One other exemplary embodiment of the disclosed subject matter is a filter; wherein the filter comprising or more shapes; wherein the one or more shapes being transparent; wherein the filter being embedded on a camera view finder; thereby enabling a user to see through the filter and underneath the filter a view that is reflected from the camera view finder.

### BRIEF DESCRIPTION OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a system for constructing and for exchanging multimedia content, in accordance with some exemplary embodiments of the disclosed subject matter;

FIG. 2 shows a block diagram of computerized device configured for editing previewing and exchanging multimedia content base messages, in accordance with some exemplary embodiments of the disclosed subject matter;

FIG. 3 shows a block diagram of computerized device configured for generating the edited multimedia content, in accordance with some exemplary embodiments of the disclosed subject matter;

FIG. 4 shows a flowchart diagram of a scenario of editing a video, in accordance with some exemplary embodiments of the subject matter;

FIG. 5 shows an exemplary block diagram of a metadata record, in accordance with some exemplary embodiments of the disclosed subject matter;

FIG. 6 shows a flowchart diagram of a method for generating and for playing the edited multimedia content, in accordance with some exemplary embodiments of the disclosed subject matter;

FIG. 7 shows a flowchart diagram of a scenario for moving multimedia objects in a video according to a full path drawn by the user, in accordance with some exemplary embodiments of the disclosed subject matter;

FIG. 8 shows a flowchart diagram for a method for moving multimedia objects in a video according to a full path drawn by the user, in accordance with some exemplary embodiments of the disclosed subject matter; and

FIG. 9 illustrates an example array representing a path for moving a media content drawn by the user.

### DETAILED DESCRIPTION OF THE INVENTION

The term multimedia content refers herein to text, audio, icons, still images, animation, video and the like or a combination thereof.

The term multimedia object refers herein to an object that is included in the multimedia content. For example, if the multimedia content is a video stream, an object may be a character in the video. Another example of a multimedia object is an animation object. An example of an animation object is an animation of a walking dog.

The term metadata refers herein to an encoding of the user commands for editing multimedia content into data that enables to replay the multimedia content with the effects of the commands.

The term original multimedia content refers herein to multimedia content before editing. An example of such multimedia content is a video of a proposal for marriage which is generated by the user.

The term edited multimedia content refers herein to multimedia content that is generated from the original multimedia content and from the metadata. The effects of the editing commands that are encoded in the metadata file are embedded in the edited multimedia content. In one example the original multimedia content a proposal for marriage is generated by a computerized device of a user (for example by a cellular phone or by a tablet); the edited multimedia content may be the video in which the user adds some animated elements, text, animations, audio and other multimedia content that has been personalized by the user

The term previewed multimedia content refers herein to multimedia content that is played according to the original multimedia content and from the metadata file. The effects of the edited command of the user are played but are not embedded into a new multimedia content. The edited commands are restored from the metadata file.

The term message based on multimedia content refers to an electronic message such as MMS that includes edited multimedia content.

The term limited resources computerized device refers herein to a computerized device that has limited resources, and in particular, does not have enough resources for editing, for storing and for exchanging a multimedia.

Examples of such resources are computing resources, archiving resources and memory resources. An example of such a computerized device is a cellular telephone and, in particular, the smart-phone. Another example is a tablet computer

The term computerized device with available resources refers herein to a computerized device that has sufficient computational and memory resources, and in particular, has enough resources for editing a multimedia, for playing and for exchanging a big multimedia content. Examples for such computerized devices with available resources are a server and a personal computer. Examples of a personal computer are a non portable computer and a laptop.

Embodiments of a system and a method for generating, playing and exchanging messages based on multimedia content are disclosed herein. According to some embodiments the multimedia content can be generated and can also be received by computerized device with limited resources. Examples of such computerized devices are cellular telephone, tablet and the like.

In some cases the editing of the messages based on multimedia content is for personalizing the messages. Such a personalized message may be used for greeting, for announcement about special events such as marriage, for expressing feeling or an idea and the like. In some embodiment the editing of the personalized messages based on multimedia content is for social interaction. Such a social interaction may be implemented through an interactive webpage used for sharing edited videos between users.

In some embodiments a filter that resides on top of the camera's view finder is provided. The filter is mainly opaque, but one or more shapes in the filter are transparent and enable the user to see through the filter and underneath the filter the view that is reflected from the camera's view finder. When using the filter the user can aim the camera such that the desired subject fits in the shape; thus the image that is captured includes only the desired subject. The user can than add a background scene below the video layer and thus create a complete scene with a background and the subject in the designated spot. Examples for backgrounds are real scene, drawn scene and cartoon scene. Such a filter module enables to add images of captured subjects to a plurality of backgrounds giving the illusion that the subject is in reality part of the background.

One technical problem dealt with by the present disclosure is to edit and exchange multimedia content by a limited resources computerized device. When generating an edited multimedia content there is a need to change each frame in the video. For example, if the user wishes to change a color of an animation, the change has to be performed on each and every frame. Thus if PAL (Phase Alternating Line) is used then the change has to be performed on each of the 25 frames that represents a second. Such editing requires big computational resources. Additionally exchanging an edited multimedia content requires high bandwidth network.

One technical solution is to encode the command for editing the original multimedia content into metadata and to save the metadata. In some embodiments the metadata file is separated from the original multimedia content. Such metadata file includes all the information that is required for performing the editing commands. Thus, there is no need to generate and to keep the edited multimedia content in the limited resources computerized device. Additionally the exchange of the messages based on multimedia content does not require high bandwidth since instead of transferring the animations, a code that represents the animation is transferred. The destination computer is capable of generating the edited multimedia content from the original multimedia content and the metadata file.

In some embodiments the metadata includes identification of the multimedia objects that are involved in the editing. The identification of the multimedia object is for retrieving the multimedia object from data repository upon editing the video; thus avoiding the transmitting of the data objects. For example, if the editing command instructs to add an animation of a bird to a certain frames of the video, the metadata that reflects this command includes the command code for “adding” and the identification of the bird animation. When editing the original multimedia content, the animation of the bird that is characterized by the identification is retrieved from a data repository. Thus when transmitting an edited multimedia content, the identification of the animation is transmitted instead of the whole animation

In some cases the metadata and the original multimedia content are sent to a remote computerized device that generates the edited multimedia content from the metadata file and from the original multimedia content. In some cases the remote computerized device is a server which enables a plurality of users to download the edited multimedia content. In some other cases the metadata file and the original multimedia content are sent to a computerized device of a single user. In such a case the single user has to first download the software for generating and exchanging message based on multimedia contents.

One other technical problem is to move a multimedia object through a full path that is drawn by the user and not only through two points that are specified by the user. Specifying two points only enable the user to draw only one line.

One technical solution is to keep metadata related to the move and to apply the move according to the metadata.

One other technical problem is to play the effects of editing commands in a limited resources computerized device.

One other technical solution is to apply the effects of the editing commands on one or more layers. For example, if the editing command includes a request for adding an animation in a specified period of a video, a layer that includes the animation is added to the device screen .Animation behavior is managed by the metadata files that containing the editing commands of the user, while synchronizing the timeline.

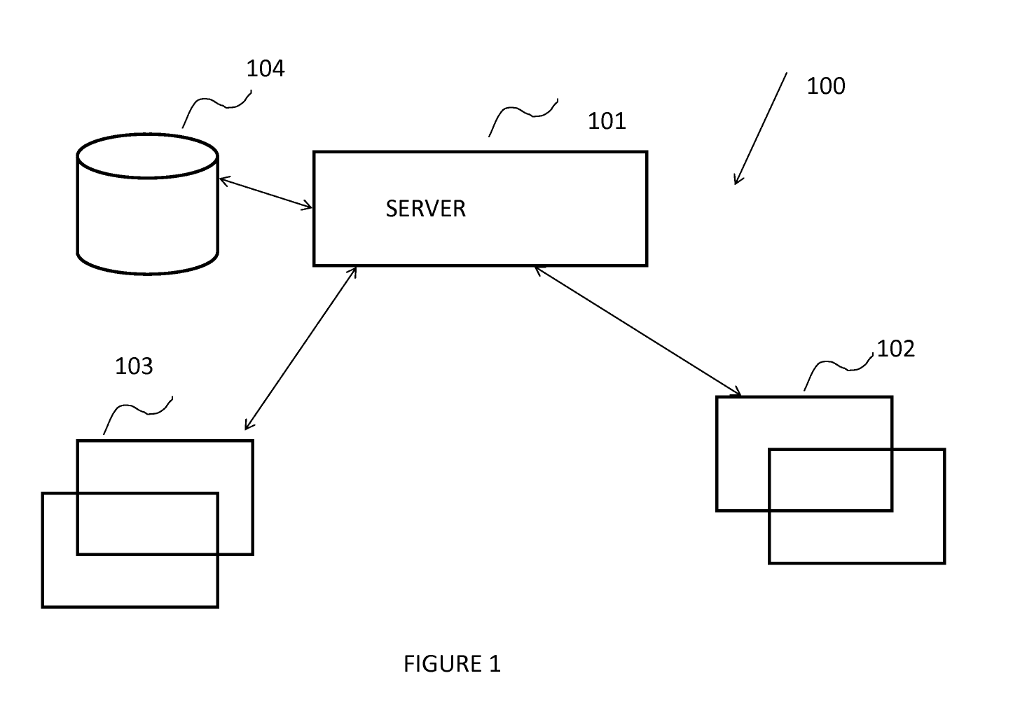

Referring now to FIG. 1, showing a block diagram of a system for constructing and for exchanging multimedia content, in accordance with some exemplary embodiments of the disclosed subject matter. System 100 comprises a sever 101, limited resources computers devices 103, computerize devices with available resources 102 and data repository 104.

The generating of the edited multimedia content may be performed on any of the limited resources computerized devices 103 or on any of the computerized devices with available resources 102. Each computerized device (from the limiter resource group 103 or from the available resources group 102) may exchange messages based on multimedia content. In some cases, a single user may wish to make the edited multimedia content available for a plurality of users. In such cases, the user may upload the original multimedia content and the metadata file to the remote server 101. The remote server 101 may generate the edited multimedia content from the original multimedia content and from the metadata file.

The edited multimedia content is stored in the data repository 104 to be downloaded to a plurality of users. The data repository 104 may also include multimedia content objects that are used in the process of generating the edited multimedia content.

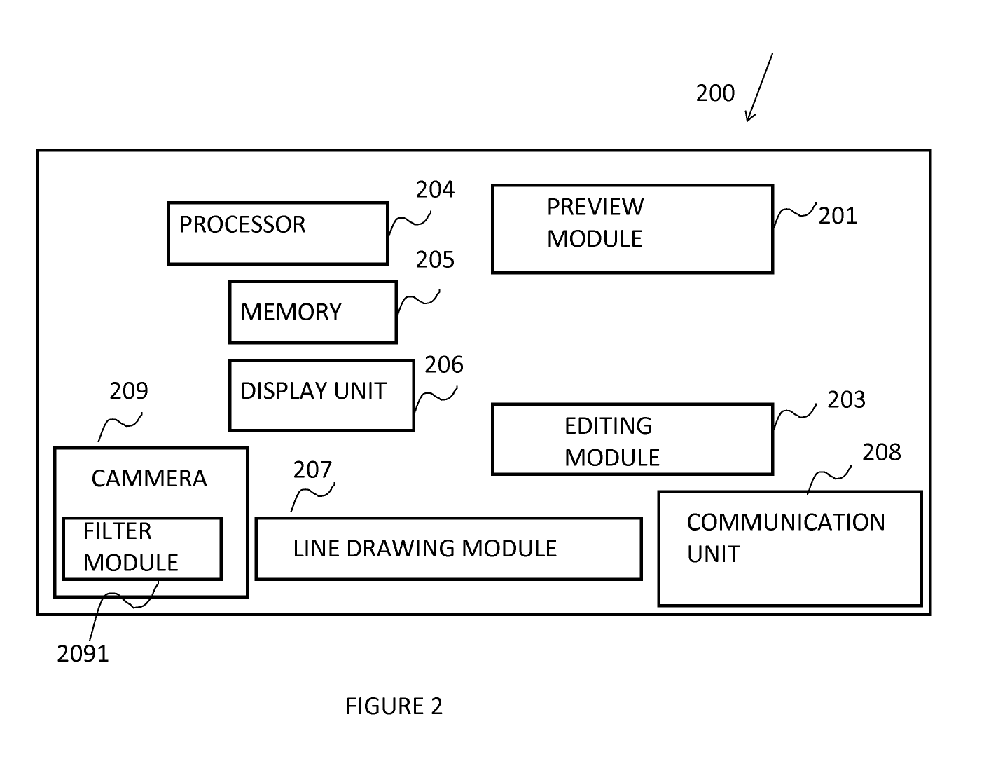

FIG. 2 shows a block diagram of a computerized device configured for editing, for previewing and for exchanging multimedia content base messages, in accordance with some exemplary embodiments of the disclosed subject matter. Computerized device 200 is typically used by a single user. The computerize device 200 is typically configured for enabling the user to issue commands for editing the multimedia content, for previewing the multimedia content with the effects of the commands and for exchanging multimedia content. In some cases the computerized device 200 is a limited resources computerized device. In some other cases the computerized device 200 is a device with available resources. In such cases, the computerized device 200 is also configured for generating edited multimedia content and for exchanging edited multimedia content.

The computerized device 200 includes a processor 204, memory 205, a display unit 206, a preview module 201, a line drawing module 207, a camera 209 and communication unit 208.

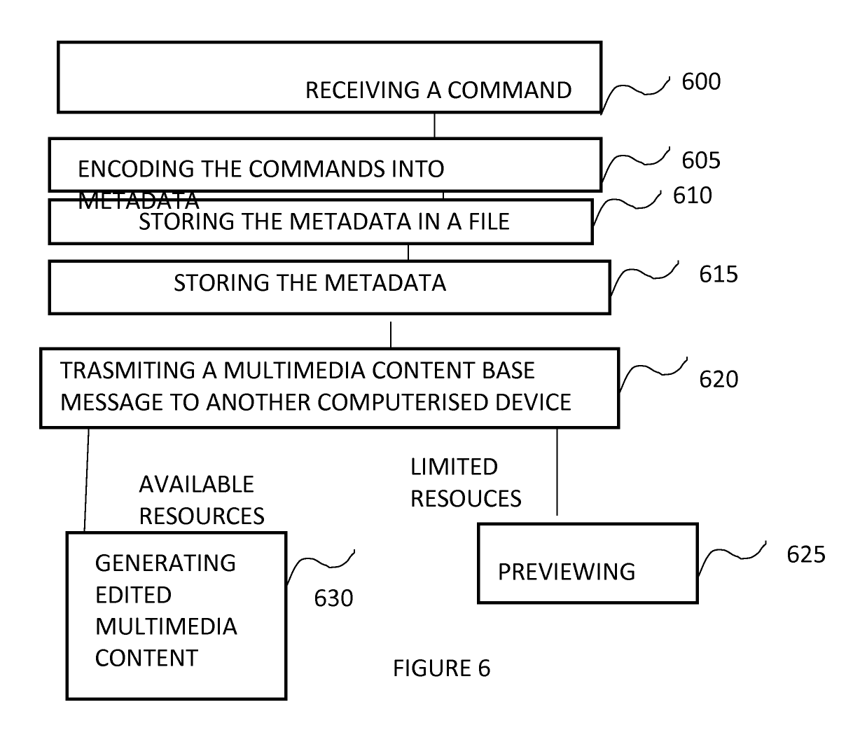

In some cases the computerized device 200 is a limited resources computerized device, in some other cases the computerized device is a computerized device with available resources. Such a computerized device may also be configured for generating edited multimedia content and, thus, may include a content generating module. The content generating module is explained in greater details in FIG. 6.

The processor 204 is configured for activating the units and modules for of the computerized device 200 which are configured for the editing of the multimedia content and for the previewing of the multimedia content.

The communication unit 208 is configured for exchanging multimedia based content messages. The display unit 206 is configured for interacting with the user and for displaying multimedia content to the user.

The editing module 203 is configured for receiving editing commands from the user and for generating the metadata.

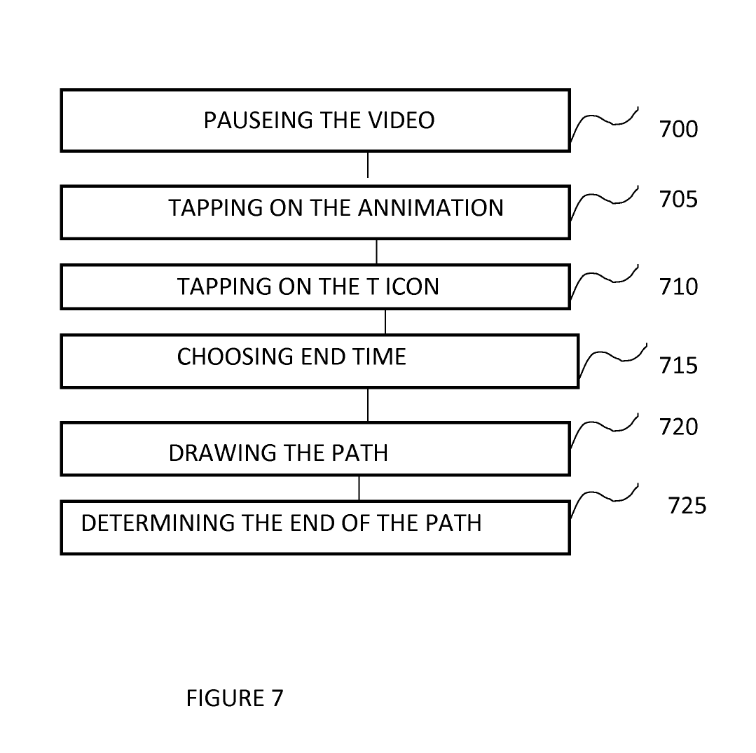

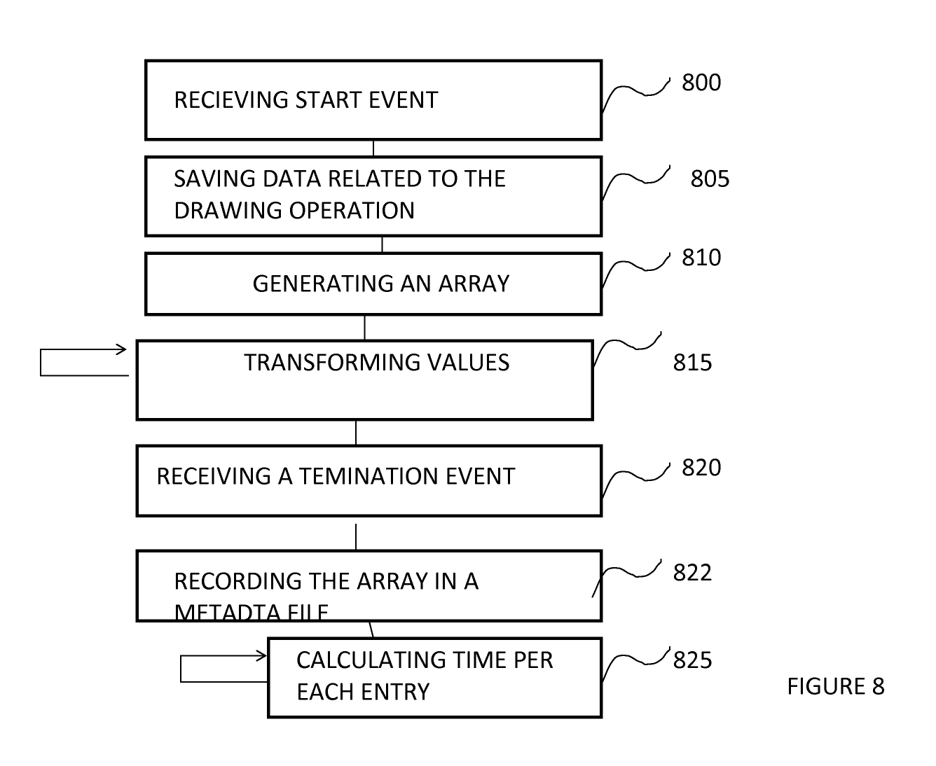

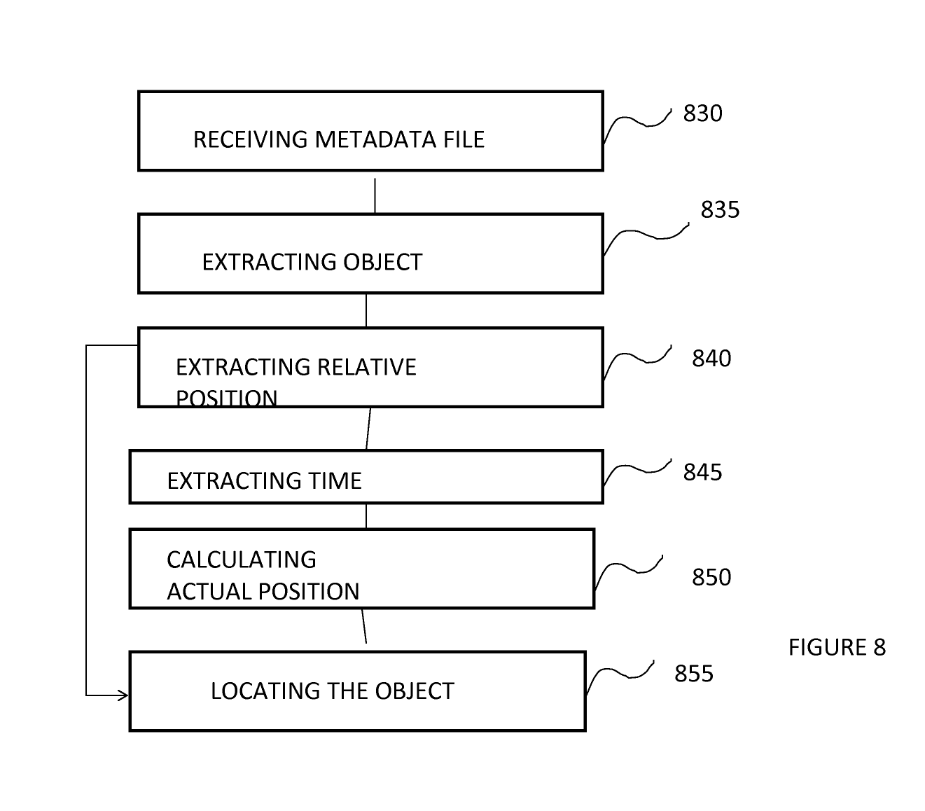

The line drawing module 207 is configured for moving multimedia objects in a video according to a full path drawn by the user. The process of moving multimedia objects in a video according to a full path drawn by the user is explained in greater details in FIGS. 7 and 8.

The preview module 201 is configured for playing the multimedia content with the effects of the editing commands. The preview process enables a user to view the effects of the editing commands on a limited resources computerized device. The preview process is based on playing the layers of the multimedia content.

The camera 209 is configured for generating multimedia content. For example the user may capture a video with the camera and may add animation and music to the video. In another example the user may capture an image of him with the camera and may insert the image to a video. In some embodiments the camera 209 is external to the computerized device 200. In some other embodiments the camera 209 is embedded in the computerized device 200. In some embodiment the camera 209 includes a filter module 2091. The filter module 2091 includes a template that resides on top of the camera's view finder. The filter module 2091 is mainly opaque, but one or more shapes in the template are transparent and enable the user to see through the filter and underneath the filter the view that is reflected from the camera's view finder. The filter module 2091 defines the pixels that should captured by the camera. The one or more shapes can be of varying sizes and shapes. Examples of such shapes are rectangle, triangle and oval.

When using the filter module 2091 the user can aim the camera such that the desired subject fits in the shape; thus the image that is captured includes only the desired subject. The user can than add a background scene below the video layer (and thus create a complete scene with a background and the subject in the designated spot. Examples for backgrounds are real scene, drawn scene, cartoon scene. Such a filter module 2091 enables to add images of captured subjects to a plurality of backgrounds giving the illusion the subject is in reality part of the background.

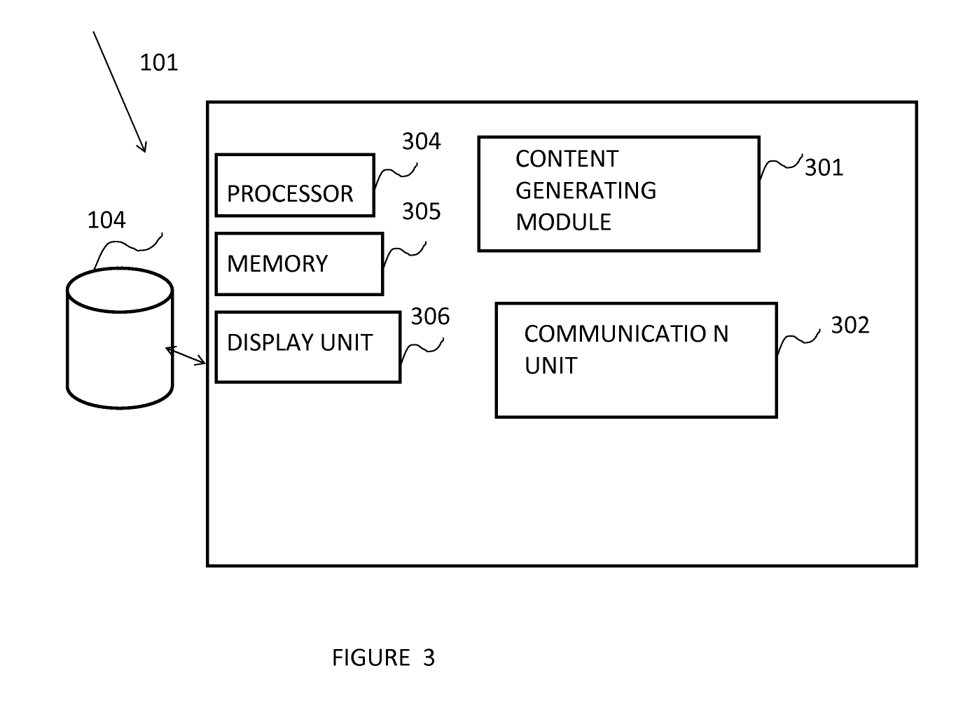

FIG. 3 shows a block diagram of computerized device configured for generating the edited multimedia content, in accordance with some exemplary embodiments of the disclosed subject matter. In some embodiments the computerized device 101 is the remote server. In some other embodiments the computerized device belongs to a personal user.

In some embodiments the computerized device 101 receives original files and metadata files from a plurality of computerized devices with limited resources. The computerized device 101 may store the generated edited multimedia content in the data repository 104 for being downloaded by a plurality of users.

Computerized device 101 includes a processor 304, memory 305, display unit 306, content generator module 301 and communication unit 302.

The processor 304 and the memory 305 are configured for enabling the generating of the edited multimedia content.

The communication unit 302 is configured for receiving the original multimedia content and the metadata files from a plurality of computerized device. The communication unit 302 is also configured for receiving requests from a plurality of users for downloading the edited multimedia content and for transmitting the edited multimedia content to the plurality of users.

The display unit 306 is configured for interacting with the user and for displaying the edited multimedia content.

The content generator module 301 is configured for generating the edited multimedia content from the original content and from the metadata files. The process of the content generator module is explained in greater details in FIG. 6.

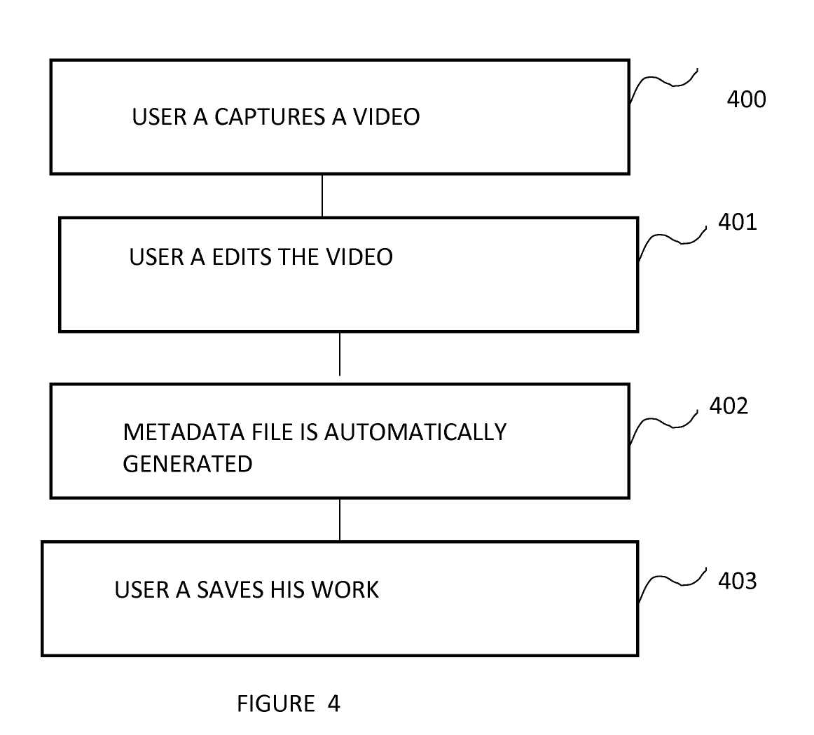

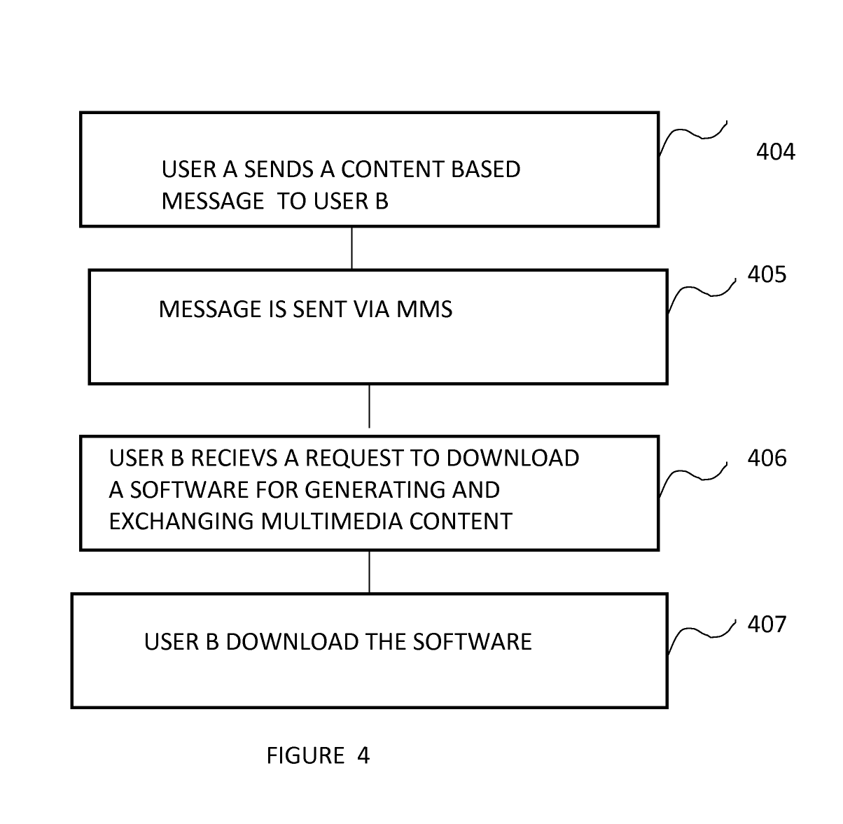

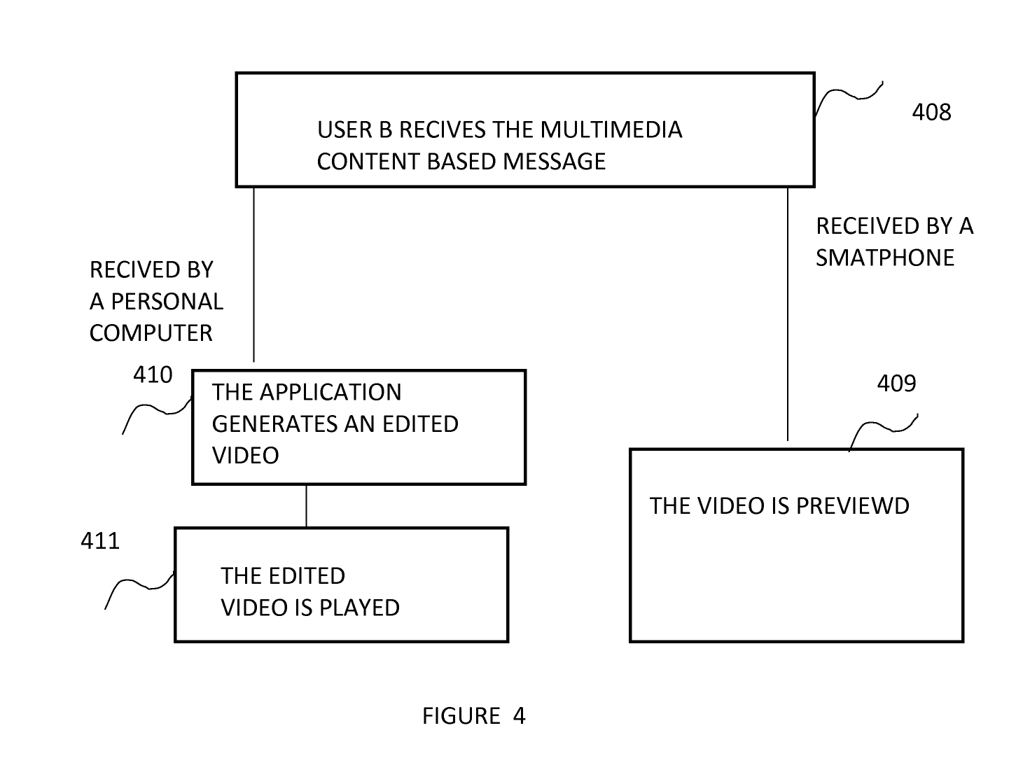

FIG. 4 shows a flowchart of a scenario of editing a video, in accordance with some exemplary embodiments of the subject matter.

At block 400, user A captures a video. For example, the video may be of the house owned by the user. If the capturing of the video is performed by an external camera, the user imports the video into his cellular telephone.

At block 401, user A edits the video. For example, the user may determine start and end point in the video, may add textual information related to the house. The user may download music and may adjust the music to the video. In some embodiments the music is combined of a prolog section, body section and an epilog section. The user may then choose the prolog section, a repetition of the body section and the epilog section. The user may also add an animation of a person and may draw a virtual path in which the person moves on the video.

At block 402, metadata file is automatically generated. The metadata file includes all the information that is required for generating the edited video according to user commands.

At block 403, user A saves his work. As a result, the metadata file is closed.

At block 404, user A requests to send a content based message that is based his work to user B.

At block 405, the video file and the meta-data file are sent via MMS.

At 406, user B receives a request to download software for generating and exchanging multimedia content.

At block 407, user B downloads the software.

At block 408, user B receives the video and the metadata file.

At block 409 which is typically performed if the video is received by a computerized device with limited resources, a preview of the video with the layers generated from the metadata file is played.

Steps 410 and 411 are typically performed if the video is received by a personal computer. At 410 the application generates the edited video. At 411 the edited video is played.

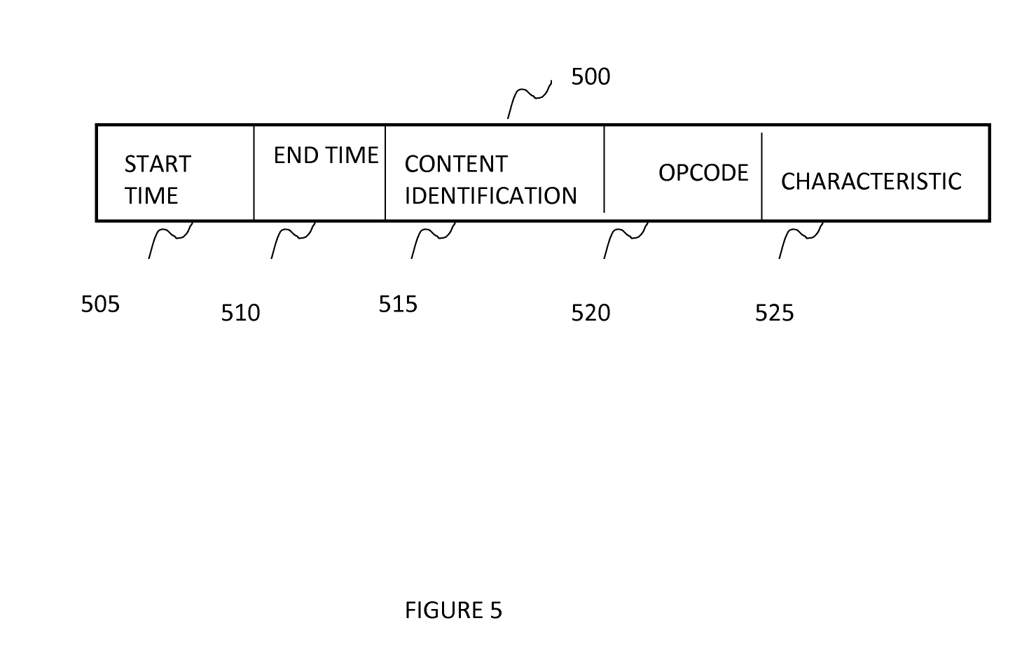

FIG. 5 shows an exemplary block diagram of a metadata record, in accordance with some exemplary embodiments of the disclosed subject matter. Meta data record 500 includes a start time filed 505, an end time filed 510, a content identification filed 515, a command-opcode 520 and characteristic 525. The start time filed 505 includes the time from which the command should be applicable. In some embodiments the start time field 505 includes the time from the beginning of the video. The end time filed 510 includes the end of the period in which the command should be applicable. In some embodiments the end time field 510 includes the time from the beginning of the video. The content identification filed 515 includes an identification of the multimedia object which is involved in the command. Command-opcode 520 includes the operational code of the command. Characteristic 525 includes the characteristic of the multimedia object that has to be changed. Examples of characteristics are colors and shapes.

In one example the command is moving a bird animation from the 5^{th} seconds to the sixth second; the command operational code is the operation code of the command “move”, the beginning filed is five seconds, the end filed is six seconds, the identification of the multimedia object is the identification of the bird in the data repository.

FIG. 6 shows a flowchart diagram of a method for generating edited multimedia content and for playing a multimedia content, in accordance with some exemplary embodiments of the disclosed subject matter.

At block 600, a command for editing multimedia content is received. In some cases the command is received from a user of a smart-phone. Examples for such commands are adding or removing a multimedia object, changing a location of a multimedia object, defining a path for moving a multimedia object, changing characteristic of a multimedia object and the like. More detailed examples of such commands are changing a color of an eye of a character in the multimedia object, moving an animation from one location to another and adding music.

At block 605, the command is encoded to metadata. The metadata is used for editing the multimedia content thereby generating a new multimedia content from the original multimedia content according to the metadata. For example, a command for changing a color of a bird animation may be encoded to a data record including the identification of the bird animation, the operation code of the command and the identification of the desired color. According to some embodiments, the metadata includes the identification of the multimedia object and not the multimedia object itself. Such an implementation provides a relatively small metadata file and improves the transmitting.

At block 610 the metadata related to the command is stored in a metadata file. The metadata file may be saved in a data repository.

At block 620 the multimedia content and the metadata file are transmitted to another computerized device. In some cases the other computerized device is a server in some other cases the other computerized device a computerized device of another user. In some cases, the computerized device of the other user is limited resources computerized device. In some other cases, the computerized device of the other user is a computerized device with available resources.

At block 625 which is preformed if the computerized device of the other user is limited resources computerized device, the multimedia content is previewed. Previewing the multimedia content is performed by decoding the command from the metadata file and by playing the layers relevant to the command in synchronization with the original multimedia content. For example if the command is for adding music to a portion of the video, the encoded command includes operational code for the command, an identification of the music and the start time and end time of the portion of the video. The decoding of the command includes the retrieving of the electronic file that includes the music which is associated with the identification of the music and the layering of this file with the video portion that corresponds to the start and end time.

At block 630 which is preformed if computerized device of the other user is a computerized device with available resources, an edited multimedia content is generated by the other computerized device. Generating an edited multimedia content includes the steps of decoding the command from the metadata file and applying the command on the multimedia content. For example if the command is for adding music to a portion of the video, the encoded command includes operational code for the command, an identification of the music and the start time and end time of the portion of the video. The decoding of the command includes the retrieving of the electronic file that includes the music which is associated with the identification of the music and applying of a layer containing the music file on each frame in the video portion that corresponds to the start and end time.

FIG. 7 shows a flowchart diagram of a scenario for moving multimedia objects in a video according to a full path drawn by the user, in accordance with some exemplary embodiments of the disclosed subject matter. An aspect of an embodiment of the invention relates to a process of moving multimedia content along a pre-defined path; wherein the path is predefined by the user and for completing the entire path within the time allocated for it by the user.

At block 700, the user pauses the video as a result of viewing the animation moving on the screen

At block 705, the user taps on the animation. As a result, the animation is selected and a white border noting to the user that the animation is selected appears on the screen. At this point, the user may tap fast forward few times in order to get to the exact initial time to start the drawing.

At block 710, which may be performed after selecting the animation and the start time, the user taps on the “T” icon in the upper right of the screen. This tapping denotes start move action. When the “T” icon is tapped, the animation is then selected with a yellow border noting to the user that the selected animation is in the process of being move.

At block 715, which occurs after the animation is selected in yellow, the user fast-forwards the video to the end time where the move action is to complete.

At block 720, which occurs when the user reaches the “end time” of the moving action, the user taps and drags the animation in any path he/she wishes the animation to move along.

At block 725 which occurs when the path is completed, the user taps the return icon which denotes the end of the path and the end of the Move action; as a result an automatic calculation is performed such that the movement starts at the start time, move along the entire path as the user defined, and finish the move exactly at the end-time as selected by the user.

It should be noted that in some other embodiments the drawing is performed by gestures of the user without touching the screen.

FIG. 8 shows a flowchart diagram for a method for moving multimedia objects in a video according to a full path drawn by the user, in accordance with some exemplary embodiments of the disclosed subject matter.

Steps 800-825 illustrate the recording of a drawn path for moving the multimedia object in accordance with some exemplary embodiments of the disclosed subject matter.

At block 800, an event indicating the start of an action for drawing a path is received. In some embodiments, the event is received after the user starts the drawing command. In some embodiments the event triggers the drawing threat. In some embodiment the drawing threat generates a periodic event which samples the path drawn by the user.

At block 805 the start time of the move as defined by the user, the end time of the move as defined by the user and the identification of the multimedia content that has been chosen by the user for the implementation of the move are received and are saved. According to some embodiments, the start time and the end time are relative to the beginning of the multimedia content and specify the period in which the path has to be drawn while playing the multimedia content. According to some embodiments the units of the start time and the end time are milliseconds.

At block 810 an array (Vector) is generated as a result of drawing the path by the user. Each entry in the array describes a pixel on the screen along the path that is drawn by the user. Each entry in the array includes X and Y coordinates of the pixel and a time stamp in which the multimedia object is expected at this pixel. In some embodiments the array is generated by a thread that executes each time an event is triggered by the device Operating system. Each time the event is triggered, a new entry is added to the array and the current position of the current location of the multimedia object is recorded in the array. The periods between each event are predefined such that the distance between two recorded pixels is relatively small. In some embodiments the distance between two adjacent entries in the array is five pixels at the most. Thus, the array represents a very accurate path that is virtually identical to the drawn by the user.

At block 815, the position is translated to a new position relative to the size of the screen of the computerized device on which the draw is performed. In particular, the X and Y coordinates are translated to relative X and Y positions and the translated values are kept in the array. As smart-phones, tablets and other devices vary in screen size with regards to dimensions and pixel density, a translation of the position is performed in order to ensure that the movement of the multimedia object through the drawn path is substantially the same in different types of screens. The translation of the position is done by calculating the relative position in the screen. Thus the translated X coordinate has the value of the ratio between the X coordinate of the pixel to the number of pixels in the width of the screen and the translated Y coordinate has the value of the ratio between the Y coordinate of the pixel to the number of pixels in the height of the screen.

For example a translated value of (100, 300) in a screen having a width of 800 pixels and a height of 600 pixels is (100/800, 300/600).

At block 820, an event for terminating the process of recording the drawing of the path is received. In some embodiments, the event is received as a result of a command from the user to terminate the drawing.

At block 822, the array is saved in a metadata file. At block 825 the time stamp for each entry in the array is calculated.

According to some embodiments the time stamp identifies the time from the beginning of the playing of the multimedia content. In some embodiments, the time stamp unit is milliseconds. According to some embodiments the time stamp assigned to a specific entry is the time in which the multimedia content is located at the position that is specified in this entry. The time stamp is calculated such that no matter what path the user chooses and no matter how long or short the drag period is, the move has to start and terminate at the start time and the end time that were identified by the user. According to some embodiments, the time recorded in the first entry of the array is the start time, the time of any other entry in calculated by subtracting the start time from the end time; by dividing the result by the number of entries in the array; by multiplying the result of the dividing with the index of the entry in the array and by adding the result of the multiplying to the start time value; Thus, each entry is assigned with time which is relative to the period in which the path is drawn and to the length of the path. For example, a first path drawn by a user and a second path drawn by a user have the same start time 3100 (in milliseconds from the start of the video) and same end time 3500 (in milliseconds from the start of the video). The first path is represented by 250 entries in the array while the second path is represented by 500 entries. An N entry in an array representing the first path has the value of 3100+(3500−3100)/250*N. An N entry in an array representing the second path has the value of 3100+(3500−3100)/300*N. When playing the move according to the second path, the animation moves through the path at double the speed the animation in the second scenario needs to move though the path as it has twice more points to go through during the same time.

Blocks 830-855 illustrate the playing of the move along the path according to the metadata file in accordance with some exemplary embodiments of the disclosed subject matter. In some embodiments the playing of the move is performed on the same computerized device on which the editing was performed, in some other embodiments the playing of the move is performed on another computerized device.

A block t 830 the metadata file which includes the instructions for playing the move is received. According to some embodiments, the instructions are recorded in an array.

At block 835, the multimedia object is extracted. According to some embodiment an identification of the multimedia object is retrieved from the metadata file and the multimedia object that is associated with the identification is extracted from a database.

Blocks 840-855 are performed per each entry in that array.

At 840, the relative position parameters of the current entry are extracted from the metadata.

At block 845, the time is extracted from the current entry of the array.

At block 850, the actual position is calculated according to the relative position parameters. For example if the user requests to play a move of a multimedia content on a phone screen with dimensions of 800 pixel wide by 600 pixels height, then an X coordinate of 76 is translated to 608 pixels from the left (800*76%) and the Y coordinate of 30 is translated to 180 pixels from the top (600*30%). Thus, the frame reflecting the move is displayed at X=608 pixels from the left edge of the screen and Y=180 pixels from the top edge of the screen. In another example the user plays the move on a tablet screen with dimensions 2500 pixels wide by 1200 pixels height, then the X coordinate 76 is translated to 1900 pixels from the left and he Y coordinate of 30 is translated to 180 pixels from the top. Thus, the frame reflecting the move in theses coordinates is displayed at X=1900 pixels from the left edge of the screen and Y=260 pixels from the top edge of the screen. Such a translation enables to draw the path on a computerized device such as a smart phone having a relatively small screen and then send the video to a computerized device having a larger screen such as a tablet with substantially no change in the move of the multimedia content along the drawn path.

At block 855, which occurs when the clock hits the time that is specified in the current entry in the array, the media content object is located at the actual position. For example if the current entry values X=76.0355 Y=30.59867 and T=2264 which means show the animation at time 2264 milliseconds in the X 76% of the screen and Y position 30% of the screen Then the media content object is placed at 75% and 30% of the screen when the clock hits 2268.

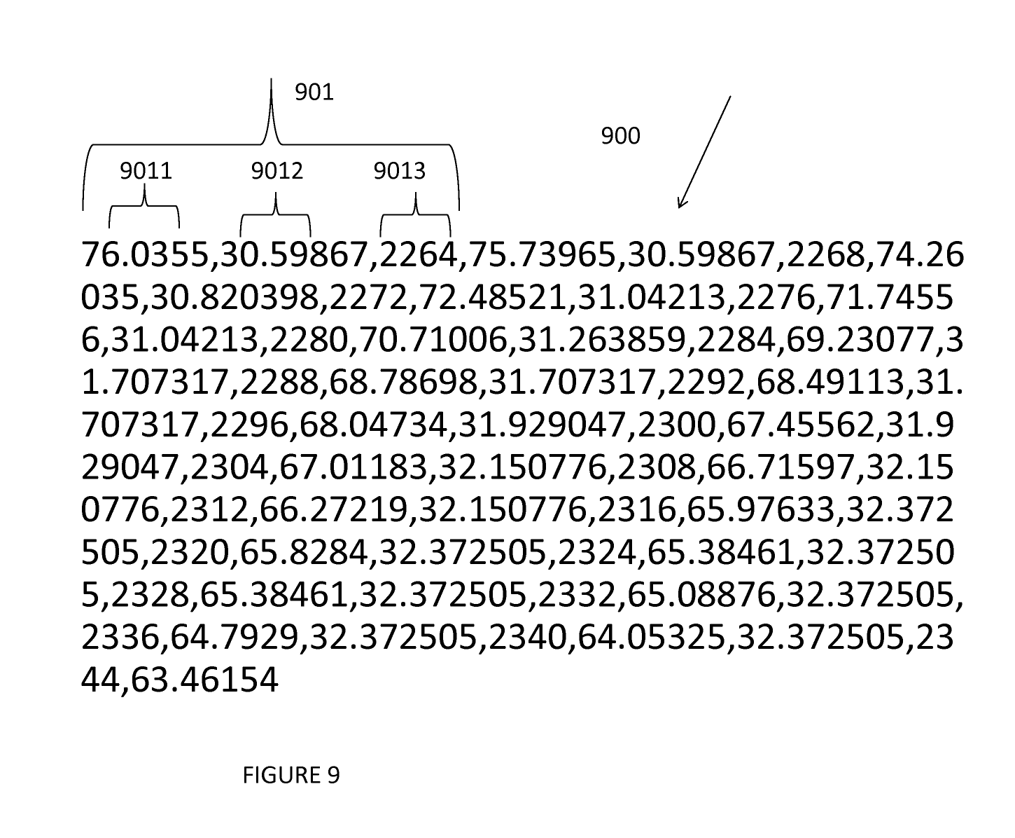

FIG. 9 illustrates an example array representing a path for moving a media content drawn by the user. Array 900 includes a plurality of entries. Each entry includes X position Y position and time. For example the first entry 901 includes X position 9011, Y position 9012 and time 9013.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A multimedia content method; comprising at a computerized device
having a processor and a memory:
receiving a command for editing a first multimedia content;
encoding said command; thereby providing an encoded command; and
recording said encoded command in a metadata file;
wherein said metadata file being used for generating an edited multimedia content from said first multimedia content according to said metadata file.

2. The method of claim 1; further comprises the step of generating said edited multimedia content from said first multimedia content according to said metadata file.

3. The method of claim 1; further comprises the step of previewing effects of said command on said first multimedia content according to said metadata file.

4. The method of claim 1; wherein said encoded command comprises one member of a group consisting of: adding a multimedia object, changing a location of a multimedia object, deleting a multimedia object, changing a characteristic of a multimedia object and defining a path for moving a multimedia object.

5. The method of claim 1; wherein said encoded command comprises an identification of said multimedia object.

6. The method of claim 1; wherein said metadata file comprising one member of a group consisting of an operational code of said command, start time, end time and an identification of a multimedia object.

7. The method of claim 1; wherein said command further comprising drawing a path for moving a multimedia object on said multimedia content; wherein said recording further comprises recording a position in the path of said multimedia object.

8. The method of claim 7, wherein said encoding further comprising translating said position to a relative position on a first screen of said computerized device.

9. The method of claim 7, further comprising translating said relative position to an actual position on a second screen.

10. The method of claim 7, wherein said encoding further comprises assigning a time stamp relative to a length of the path and to the period in which said path is drawn, and further comprising locating said multimedia object in said actual position at said time stamp.

11. A method for moving a multimedia object on a multimedia content;
the method comprises:
receiving a position of a multimedia object along a path drawn by a user;
translating said position to a relative position on a first screen; and
assigning a time stamp to said position wherein said time stamp being relative to a length of the path and to the period in which said path is drawn; thereby providing a metadata for the moving of the multimedia object.

12. The method of claim 16, further comprising the step of translating said relative position to an actual position on a second screen.

13. The method of claims and 16, 17, further comprising the step of locating said multimedia object in said actual position at said time stamp.

14. A method for moving a multimedia object on a multimedia content;
comprising, at a computerized device having a processor and a memory:
receiving a metadata file;
extracting a relative position from said metadata file; and
translating said relative position to an actual position of a screen of said computerized device;
extracting a time from said metadata file;
extracting a metadata object from said metadata file; and
locating said metadata object on said actual position of said screen;
wherein said locating being at said time stamp.
